(19) United States
(12) Patent Application Publication
(10) Pub. No.: US 2010/0260950 A1
(43) Pub. Date: Oct. 14, 2010

(54) PILLAR ARRANGED IN VACUUM GLAZING

(75) Inventor: Jianzheng Tang, Beijing (CN)

Correspondence Address: EDWARDS ANGELL PALMER & DODGE LLP, P.O. BOX 55874, BOSTON, MA, 02205, US

(73) Assignee: Beijing Synergy Vacuum Glazing Technology Co., Ltd., Beijing (CN)

(21) Appl. No.: 12/752,319

(22) Filed: Apr. 1, 2010

(30) Foreign Application Priority Data
Apr. 10, 2009 (CN) 200920147601.X

(51) Int. Cl. E06B 3/663

(52) U.S. Cl. 428/34.4; 428/156

(57) ABSTRACT

A pillar arranged in vacuum glazing, the pillar is ring-shaped or column-shaped, wherein at least one groove whose depth is no greater than the thickness of the pillar is formed on the upper surface and/or the lower surface of the pillar. The pillar could be made of metallic material such as stainless steel or other metal or alloy whose hardness is high enough, or non-metallic material such as ceramics or special glass.

### CROSS-REFERENCE TO RELATED APPLICATION

This application claims priority to Chinese patent application no. 200920147601.X filed on Apr. 10, 2009 in its entirety.

### BACKGROUND OF THE INVENTION

This utility model relates to a pillar with new structures, which is arranged in vacuum glazing. It is well known that the basic structure of the vacuum glazing is formed by arranging two sheets of plate glass having substantially the same size to face each other, sealing up and vacuum-pumping them to form a vacuum layer, thereby the physical properties of thermal insulation and acoustical insulation are realized, which opens up a vast range of prospects for the application of the vacuum glazing in building facilities. An array of pillars arranged between these two glass sheets bears great pressure. The structures of the pillars arranged in vacuum glazing used in prior arts are cylindrical, ring-shaped, oval-shaped, drum-shaped, C-shaped, cross-shaped, etc. The cylindrical and ring-shaped pillars are more popular among the above illustrated pillars.

However, there are disadvantages in structures of these two pillars particularly concerned in the Chinese patent application No. 95108228.0 whose inventor is also the inventor of this application. The cylindrical pillar has poor transparency, large contact areas with the glass, and high heat conduction. Moreover, since the force acting on the pillars is mainly focused on the periphery, the middle portion conducts heat and holds little pressure.

Furthermore, there is still residue gas left on the upper and lower surfaces of the pillar after vacuum-pumping, and the residue gas cannot be discharged. The ring-shaped pillar is further improved as compared to the cylindrical pillar, the middle portion of which held little pressure is removed, thereby material is saved and heat conduction is reduced; however, the residue gas in the middle portion still cannot be discharged, which reduces the vacuum degree of the vacuum glazing. The C-shaped pillar makes an opening on the basis of the ring-shaped pillar; although it solves the problem of discharging the inner residue gas, it brings a difficulty to the manufacture of the C-shaped pillar, because if the size of the opening exceeds the thickness of the pillar, the pillars will hook with each other, which brings difficulty to pillar arrangement.

### BRIEF SUMMARY OF THE INVENTION

An object of this utility model is to provide a pillar arranged in vacuum glazing with new structures which can overcome the above-mentioned problems.

The pillar arranged in vacuum glazing of this utility model is characterized in that, the pillar is ring-shaped or column-shaped, wherein at least one groove whose depth is no greater than the thickness of the pillar is formed on the upper surface and/or the lower surface of the pillar. The pillar could be made of metallic material such as stainless steel or other metal or alloy whose hardness is high enough, or non-metallic material such as ceramics or special glass.

Thus formed pillar of vacuum glazing of this utility model has the advantageous technical effects of realizing better thermal insulation and easy air exhaustion while having good supporting effect, and it is easy to manufacture the pillar as well as arrange the pillar during the manufacture of the vacuum glazing.

### BRIEF DESCRIPTION OF THE DRAWINGS

FIG. 1 shows examples of the pillar arranged in vacuum glazing of this utility model.

### DETAILED DESCRIPTION OF THE PREFERRED EMBODIMENT

Firstly, please note that although the spirit of this utility model is illustrated by using a round shape, the pillar arranged in vacuum glazing of this utility model can use any other shapes such as regular polygon, ellipse, etc. The scope of protection of this utility model is defined by the attached claims.

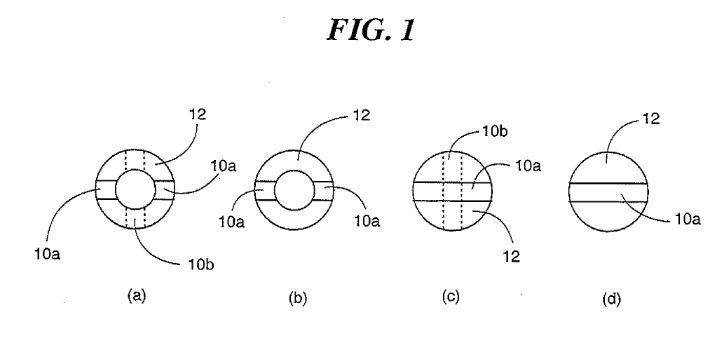

As illustrated in FIG. 1, the number of grooves generally shown as 10 on the single surface of the round ring-shaped pillar 12 in (a)-(d) is at least one, but two or more also works practically. One surface of a cylindrical pillar 12 (i.e. column-shaped pillar with round-shaped cross section) is provided with at least one groove 10a, and the groove on the upper surface 10a could be parallel to or crossed with the groove 10b on the lower surface (see FIG. 1). Furthermore, there may be multiple grooves arranged symmetrically on one surface. The number of grooves is not limited, but it is preferable the number of grooves 10 of the upper surface be the same as the number of grooves 10 of the lower surface if the upper surface and the lower surface are both provided with grooves. Theoretically, if there are more grooves, the areas of the pillar contacting with the upper and lower plate glass sheets will be smaller, and the effect of thermal insulation will be better. However, the number of grooves 10 should not be too large because point contacts may appear between the pillars and the upper and lower plate glass sheets, which will produce undesirable breaking stress.

The surface of the cylindrical pillar may be provided with multiple grooves 10, the number of which is not limited, while obviously there could be grooves 10 on only one surface. Preferably, the number and position of grooves 10 of the upper surface are corresponding to the number and position of grooves of the lower surface.

The shapes of the outer periphery of the cylindrical pillar as well as the inner and outer peripheries of the ring-shaped pillar may be polygons of all kinds, and the number of the grooves 10 on the surface of which is not limited.

The pillar of the utility model could be made of metallic material such as stainless steel or other metal or alloy whose hardness is high enough, or non-metallic material such as ceramics or special glass.

The advantageous technical effects of this utility model could be summarized as follows:

Firstly, in terms of force, the round ring-shaped pillar bears even force on the periphery, while the C-shaped pillar bears uneven force; secondly, in terms of thermal conduction, the round ring-shaped pillar uses less materials, thereby the heat conducted by the round ring-shaped pillar is reduced; thirdly, the function of the open grooves on the upper surface and the lower surface of the round ring-shaped pillar is equivalent to that of an air exhaust passage for discharging the inner gas. The open grooves on the surface of the cylindrical pillar also make contribution to the discharge of the gas of the surface.

What is claimed as new and desired to be protected by Letters Patent of the United States is:

1. A pillar arranged in vacuum glazing, comprising:
a pillar, said pillar is one of a ring-shape and a column-shape, and at least one groove, the groove having a depth, the depth no greater than a thickness of said pillar, formed on at least one of an upper surface and a lower surface of said pillar.
